(19) United States
(12) Patent Application Publication
(10) Pub. No.: US 2023/0264827 A1
(43) Pub. Date: Aug. 24, 2023

(54) ACTIVE TURBULENCE SUPPRESSION SYSTEM AND METHOD FOR A VERTICAL TAKE OFF AND LANDING AIRCRAFT

(71) Applicant: United States of America as represented by the Administrator of NASA, Washington, DC (US)

(72) Inventor: Guru Pillappa GURUSWAMY, Sunnyvale, CA (US)

(21) Appl. No.: 18/171,268

(22) Filed: Feb. 17, 2023

Related U.S. Application Data
(60) Provisional application No. 63/268,246, filed on Feb. 18, 2022.

(51) Int. Cl. B64D 31/12; B64C 29/00

(52) U.S. Cl. CPC B64D 31/12; B64C 29/0025

(57) ABSTRACT

A system can include a controller that can generate a query request in response to an instantaneous roll angle of a vertical take off and landing (VTOL) aircraft being equal to or greater than a roll angle threshold. The instantaneous roll angle being equal to or greater than the roll angle threshold can indicate that the VTOL aircraft has deviated or is about to deviate from a current stable aircraft state. A database can provide propeller control data identifying a propeller speed profile for at least one propeller of the VTOL aircraft in response to the query request. The database can store different propeller speed profiles for at least some propellers of the VTOL aircraft for respective roll angles. The controller can cause the at least one propeller of the VTOL aircraft to rotate at the propeller speed to return the VTOL aircraft to the stable aircraft state.

### RELATED APPLICATION

This application claims priority to U.S. Provisional Application No. 63/268,246, filed Feb. 18, 2022, and entitled “Active Control Mechanism for Lift+Cruise Air Taxi,” the subject matter of which is incorporated herein by reference in its entirety.

### ORIGIN OF INVENTION

The invention described herein was made by an employee of the United States Government and may be manufactured and used by or for the Government of the United States of America for governmental purposes without the payment of any royalties thereon or thereof.

### TECHNICAL FIELD

The present disclosure relates to systems and methods for aerial vehicle stabilization.

### BACKGROUND

A vertical take off and landing (VTOL) aircraft is one that can hover, take off, and land vertically without relying on a runway. This classification can include a variety of types of aircraft including helicopters as well as thrust vectoring fixed wing aircraft and other hybrid aircraft with powered rotors such as cyclogyros/cyclocopters and gyrodynes. An eVTOL aircraft is a variation of a VTOL aircraft that uses electric power to hover, take off, and land vertically. During flight, the VTOL aircraft can exhibit instabilities such as a Dutch-roll oscillation or motion. Dutch roll is a type of aircraft motion consisting of an out of phase combination of “tail wagging” (yaw) and rocking from side to side (roll). The aircraft rolls in one direction and yaws in the other resulting from out of phase turns. Dutch roll can happen naturally and other times it happens due to unexpected atmospheric disturbances such as gust.

### SUMMARY

In an example, a system can include a controller that can be configured to receive sensor data characterizing at least an instantaneous roll angle of a VTOL aircraft, and generate a query request in response to the instantaneous roll angle being equal to or greater than a roll angle threshold. In some embodiments, the roll angle threshold can be a defined static value, or a value relative to a nominal roll angle at that instant. The instantaneous roll angle being equal to or greater than the roll angle threshold can indicate that the VTOL aircraft has deviated or is about to deviate from a current stable aircraft state. The system further includes a database that can be configured to provide propeller control data identifying a respective propeller speed profile for one or more propellers of the VTOL aircraft in response to the query request. The database can store different propeller speed profiles for the one or more propellers of the VTOL aircraft for respective roll angles. The controller can be further configured to cause the one or more propellers of the VTOL aircraft to rotate at the respective propeller speed profile to return the VTOL aircraft to the stable aircraft state.

In a further example, a method can include receiving roll angle sensor data characterizing an instantaneous roll angle of a VTOL aircraft and generating a query request in response to the instantaneous roll angle being equal to or greater than the roll angle threshold. The instantaneous roll angle being equal to or greater than the roll angle threshold can indicate that the VTOL aircraft has deviated or is about to deviate from a current stable aircraft state in response to an external force acting on a respective wing of a set of wings of the VTOL aircraft. The method can further include identifying at least one propeller of a plurality propellers of the VTOL aircraft positioned on the respective wing of the VTOL aircraft for counteracting the external force acting on the respective wing to return the VTOL aircraft to the stable aircraft state, and searching a turbulence suppression database for a propeller speed profile for the at least one propeller based on the query request. The turbulence suppression database can store different propeller speed profiles for propellers for respective roll angles. The method can further include generating propeller activation data that includes the propeller speed profile and causing the at least one propeller to rotate at the propeller speed profile to generate a force to counteract the external force to push the respective wing in an opposite direction of the external force to return the VTOL aircraft to the stable aircraft state based on the propeller activation data.

In yet another example, a VTOL aircraft can include a fuselage, at least two wings extending from the fuselage, a push propeller positioned at a rear of the fuselage, a plurality of lift propellers equally distributed on the at least two wings and an active turbulence suppression (ATS) system. The ATS system can be configured to generate propeller control data identifying a respective propeller speed profile for at least one lift propeller of the plurality of propellers located on a respective wing of the at least two wings in response to querying a turbulence suppression database. The turbulence suppression database can store different propeller speed profiles for propellers of the VTOL aircraft for respective roll angles. The turbulence suppression database can be queried in response to the ATS system determining that an instantaneous roll angle of the VTOL aircraft is equal to or greater than a roll angle threshold. The instantaneous roll angle being equal to or greater than the roll angle threshold can indicate that the VTOL aircraft has deviated or is about to deviate from a stable aircraft state in response to turbulence. The ATS system can be further configured to cause the at least one lift propeller of the VTOL aircraft to rotate at the respective propeller speed to return the VTOL aircraft to the current state.

### BRIEF DESCRIPTION OF THE DRAWINGS

FIG. 1 is an example of a flight control system for a VTOL aircraft.

FIG. 2 is an example of a VTOL aircraft.

FIG. 3 is an example of a VTOL flight profile.

FIG. 4 is an example of a method for adjusting flight characteristics of a VTOL aircraft.

FIG. 5 is an example of a computing system for generating turbulence suppression data.

FIG. 6 is an example of a diagram illustrating a side slip angle for a VTOL aircraft model.

FIG. 7 is an example of a plot of surface pressures and Mach contours when right wing outboard propellers are activated of a VTOL aircraft model.

FIG. 8 is an example of a plot of surface pressures and Mach contours when left wing outboard propellers are activated of a VTOL aircraft model.

### DETAILED DESCRIPTION

This disclosure relates to an active turbulence suppression (ATS) system for an electrical aircraft, such as an eVTOL aircraft. eVTOL aircraft are used to transport cargo and/or passengers (e.g., as air-taxis). eVTOL aircraft are battery powered aircraft and are generally lighter in weight in comparison to jet fuel powered VTOL aircraft. eVTOL aircraft are light weight, fly at low altitudes (e.g., in comparison to commercial aircrafts), and are susceptible to turbulences. The term turbulence and derivatives thereof, as used herein, can include gusts of wind, such as vertical gusts of wind, that cause a VTOL aircraft to undesirably change flight dynamics. Turbulence can cause the eVTOL aircraft during flight (e.g., cruise) to go into a Dutch-roll oscillation. A Dutch roll is a combination of rolling and yawing oscillations that occur when dihedral effects on the eVTOL aircraft are more powerful than a directional stability of the VTOL aircraft.

eVTOL aircraft are generally not built for such instabilities (e.g., the Dutch-roll oscillation), and if not suppressed, can impact safety and comfort of passenger(s), or cargo on board. Control surfaces are generally not used to suppress the Dutch-roll oscillation as an eVTOL aircraft design generally has propellers placed on leading and trailing edges and this provides no room for the control surfaces. Moreover, use of control surfaces in eVTOL aircraft design is undesirable as such components would add weight and complexity to the eVTOL aircraft, leading to a reduction in aircraft efficiency.

According to the examples herein, an ATS system and method are presented for mitigating (e.g., reducing or in some instances completely eliminating) effects of turbulent conditions that lead to a Dutch-roll oscillation of a VTOL aircraft, such as an eVTOL aircraft. The VTOL aircraft can be a manned or an unmanned aerial vehicle (UAV) type. The ATS system includes a controller that can receive sensor data characterizing at least an instantaneous roll angle of the VTOL aircraft. The ATS system includes a turbulence suppression database that can be queried by the controller to identify a respective propeller speed profile for at least at least one propeller of the VTOL aircraft.

For example, the controller can be configured to generate a query request in response to the instantaneous roll angle being equal to or greater than a roll angle threshold. The instantaneous roll angle being equal to or greater than the roll angle threshold can indicate that the VTOL aircraft has deviated or is about to deviate from a current stable aircraft state to an undesirable, unstable and oscillating aircraft state. The turbulence suppression database can be configured to provide propeller control data identifying a respective propeller speed profile for the at least one propeller of the VTOL aircraft in response to the query request. The database stores different propeller speed profiles for propellers of the VTOL aircraft for respective roll angles. The controller can be configured to cause the at least one propeller of the VTOL aircraft to rotate at the respective propeller speed profile to return the VTOL aircraft to the stable aircraft state and thus mitigate or eliminate turbulence effects on the VTOL aircraft, such as Dutch-roll-oscillation-causing effects.

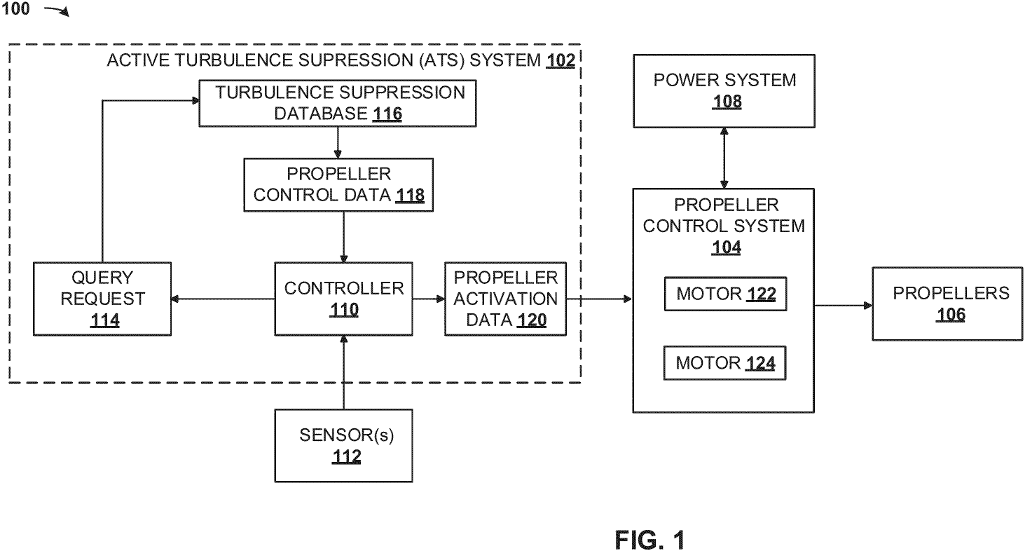

FIG. 1 is an example of a flight control system 100 for a VTOL aircraft. The flight control system 100 can be used to adjust flight dynamics of the VTOL aircraft. For example, the flight control system 100 can be used to control at least a direction of the VTOL aircraft and attitude (e.g., during take off, cruise, and/or landing, and under conditions of instability or disturbance, such as Dutch-roll oscillations). The flight control system 100 can include an ATS system 102 for mitigating or reducing effects of turbulent conditions on the VTOL aircraft that can cause the VTOL aircraft to oscillate in a Dutch-roll motion. The ATS system 102 can be configured to communicate with a propeller control system 104 to control propellers 106 of the VTOL aircraft. In some examples, the propeller control system 104 is an electronic propeller control system (EPCS). The propeller control system 104 can include one more mechanisms and/or components for adjusting at least a speed and in some instances a blade angle of one or more of the propellers 106.

The propeller control system 104 can be powered by a power system 108 of the VTOL aircraft. In one example, the power system 108 is a battery power system that includes one or more batteries (e.g., Lithium-ion cells). In other examples, the power system 108 is a hydrogen fuel cell system or a hybrid-electric power system. The propeller control system 104 can include one or more motors (e.g., electrical motors) that can be powered (e.g., driven) by a power outputted by the power system 108, for example, to rotate the one or more propellers 106. While the example of FIG. 1 illustrates the power system 108 powering the propeller control system 104, the power system 108 can be used to power other systems such as the ATS system 102 of the VTOL aircraft.

In some examples, the propellers 106 can include one or more lift propellers and one or more push propellers. The lift propellers can be distributed along respective wings of the VTOL aircraft. The push propeller (or a set of push propellers) can be positioned near a rear of a fuselage of the VTOL aircraft. The lift propellers can be activated during selective phases of a VTOL flight profile for the VTOL aircraft. The VTOL flight profile can include a takeoff phase, a climb phase, a cruise phase, a descent phase, and a landing phase. Generally, the lift propellers are activated (e.g., powered by the power system 108) during the takeoff, climb, descent, and landing phases for thrust generation to increase or decrease an altitude of the VTOL aircraft, and the push propeller is deactivated (e.g., not being powered by the power system 108). At or near the cruise phase, the lift propellers of the VTOL aircraft are deactivated, and the push propeller is activated to provide thrust to move the VTOL aircraft through air (e.g., in a forward direction). The propellers 106 can include a number of blades based on a design, a constraint, and an application of the VTOL aircraft.

As shown in FIG. 1, the ATS system 102 includes a controller 110 for implementing a turbulence mitigation method. The controller 110 can be implemented in hardware, software, and/or a combination thereof. For example, the controller 110 may include a memory storing machine readable instructions for implementing the turbulence mitigation method. The controller 110 can include at least one processor (e.g., a central processing unit (CPU)) (not shown in FIG. 1). By way of example, the CPU can be a be a complex instruction set computer (CISC)-type CPU, reduced instruction set computer (RISC)-type CPU, microcontroller unit (MCU), or digital signal processor (DSP). The memory can include random access memory (RAM)). In additional examples, the memory includes other types of memories (e.g., on-processor cache, off-processor cache, RAM, flash memory, or disk storage). In some examples, the controller 110 can be representative of coded instructions (e.g., computer and/or machine readable instructions) that can be implemented on one or more flight control computing platforms (e.g., a special purpose computer for controlling flight conditions of the VTOL aircraft, for example, a flight computer), hardware, and/or one or more other systems of the VTOL aircraft.

The controller 110 can be configured to receive sensor data from one or more sensor(s) 112. The sensor data can pertain to any sensed condition on the VTOL aircraft or outside the VTOL aircraft, including but not limited to, motor data, avionics data, altitude data, flight control data, positional data, fuel data, weather data, and any other types of aircraft data for which a condition can be sensed. For example, the one or more sensor(s) 112 can include a side slip angle sensor for determining an instantaneous side slip angle (β) of the VTOL aircraft. In some examples, the one or more sensor(s) 112 include a bank angle (or roll angle) sensor for determining an instantaneous bank angle (Φ) of the VTOL aircraft. The bank angle sensors may be wing arranged. By way of further example, the one or more sensor(s) 112 can include a six-axis inertial sensor for determining a real-time roll angle of the VTOL aircraft. In further examples, the one or more sensor(s) 112 can include inertial sensors and/or velocity sensors for respectively sensing acceleration and/or velocity of the VTOL aircraft.

For example, the controller 110 can be configured to receive roll angle sensor data from the one or more sensors 112. The roll angle sensor data can characterize an instantaneous roll angle of the VTOL aircraft. In other examples, the controller 110 can be configured to receive sensor or measurement data (e.g., inertia, velocity, position, attitude, acceleration, and/or the like) for determining the instantaneous roll angle of the VTOL aircraft. The roll angle of the VTOL aircraft can be determined with respect to a longitudinal axis of the VTOL aircraft. The controller 110 can be configured to compare the instantaneous roll angle of the VTOL aircraft to a roll angle threshold. The controller 110 can compare the instantaneous roll angle to the roll angle threshold through a flight of the VTOL aircraft, or in response to receiving data (e.g., from another system) indicating that the VTOL aircraft is at cruise (e.g., at a cruise altitude). While examples are described herein wherein the instantaneous roll angle is compared to the roll angle threshold for implementing the turbulence mitigation method, in other examples, an instantaneous roll angle deviation can be established relative to the roll angle threshold that is defined relative to a nominal roll angle, and the method can be activated in response to the instantaneous roll angle deviation being at or exceeding the roll angle threshold that is defined relative to a nominal roll angle.

Generally, during flight, the VTOL aircraft maneuvers in three (3) directions such as in a longitudinal, lateral, and vertical axis. These are perpendicular to each other and intersect at a center of gravity of the VTOL aircraft. Motions around the longitudinal axis, the lateral axis, and the vertical axis are referred to as roll, pitch, and yaw respectively. During the cruise phase, the VTOL aircraft can encounter turbulence, which causes the VTOL aircraft to rotate along the longitudinal axis. The turbulence can lead to VTOL aircraft instabilities, such as a Dutch-roll oscillation. For example, a vertical gust (e.g., movement of wind) can create an external force that can act on a respective wing of the VTOL aircraft to cause the VTOL aircraft to rotate about the longitudinal axis. The external force created by the vertical gust can push the respective wing in an upward or downward direction, which causes the VTOL aircraft to roll by a given angle amount with respect to the longitudinal axis, and the VTOL aircraft can sideslip.

In some examples, a flight computer receives automated input that the VTOL aircraft is oscillating off-nominally (e.g., oscillating in yaw or Dutch-roll oscillations) from a detection module detecting an off-nominal pattern of oscillations from sensor data input. In examples wherein the VTOL aircraft is manually operated (e.g., via a pilot), the flight computer receives input from the operator user interface indicating that the VTOL aircraft is oscillating off-nominally. In further examples, the detection module may include an auto-pilot system, and/or machine-learning (ML) model trained for detecting flight motions of a VTOL aircraft (e.g., yaw oscillations or Dutch-roll oscillations). In response, the flight computer can issue a command to the controller 110 to cause the controller 100 to implement the turbulence mitigation method, such as the method described herein, to mitigate the Dutch-roll motion. Thus, in some instances, the flight computer of the VTOL aircraft can make a determination of when to implement the turbulence mitigation method as described herein.

The controller 110 can be configured to compare the instantaneous roll angle for the VTOL aircraft to the roll angle threshold. The controller 110 can be configured to implement the turbulence mitigation method in response to determining that the instantaneous roll angle is equal to or greater than the roll angle threshold. The controller 110 can be configured to generate a query request 114 in response to the comparison indicating that the instantaneous roll angle is equal to or greater than the roll angle threshold. The query request 114 may identify the instantaneous roll angle for the VTOL aircraft, and be provided to a turbulence suppression database 116. The turbulence suppression database 116 can store precomputed data such as time and propeller speeds for different roll angles, rate of change of roll angle, direction of rate of change, and so on.

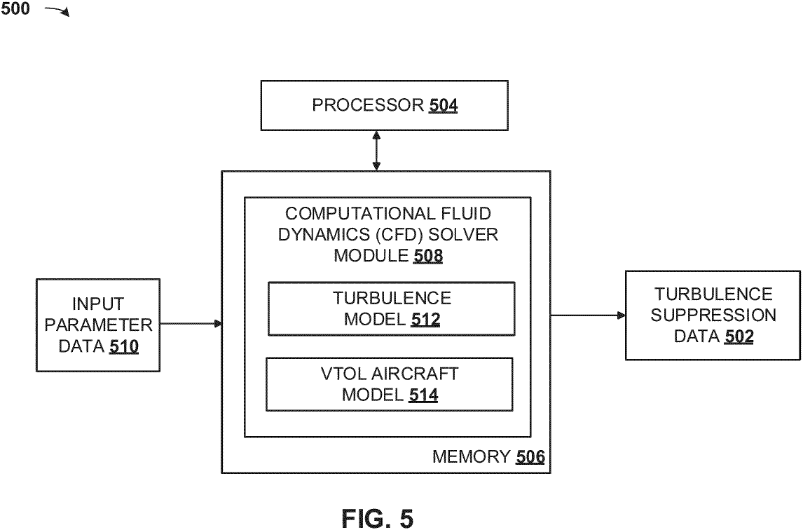

The precomputed data can correspond to turbulence suppression data (e.g., turbulence suppression data 502, as shown in FIG. 5), which can be determined prior to a flight of the VTOL aircraft, such as using simulations and models, algorithms and/or applications (e.g., software), as described herein. Each propeller speed in the turbulence suppression database 116 can be associated with a respective time entry and a roll angle in the turbulence suppression database 116. The respective time entry can specify an amount of time that respective lift propellers of the propellers 106 are activated. For example, if the respective time entry corresponds to three (3) seconds, the lift propellers of the propellers 106 can be activated for three (3) seconds to counteract the external force. The turbulence suppression database 116 can provide propeller control data 118 to the controller 110 based on the query request 114. The propeller control data 118 can identify a respective propeller speed and time entry information associated with the instantaneous roll angle in the turbulence suppression database 116. In some examples, the controller 110 can receive wing data corresponding to the sensor data from the one or more sensor(s) 112, which can be indicative that the respective wing is experiencing an external force. In other examples, a different system of the VTOL aircraft can provide the wing data to the controller 110.

The controller 110 can provide propeller activation data 120 to the propeller control system 104 for selective activation of one or more lift propellers of the propellers 106. For example, the propeller activation data 120 can identify a subset of lift propellers of the lift propellers that are located on the respective wing of the VTOL aircraft, and specify a propeller speed for the subset of lift propellers. In some examples, the propeller activation data 120 can further include the time entry information specifying how long the one or more lift propellers are to be activated. The propeller control system 104 can communicate with the power system 108 to receive power for driving one or more motors 122 and 124 associated with the one or more lift propellers identified in the propeller activation data 120 in response to receiving the propeller activation data 120. The propeller control system 104 can cause the one or more lift propellers to be rotated at the propeller speed specified by the propeller activation data 120, and in some examples, according to the time entry information. In certain embodiments the propeller activation data 120 includes a propeller speed profile indicating propeller speed, duration, and/or propeller acceleration and deceleration parameters.

The one or more lift propellers in response to being activated to rotate at a specified propeller speed profile can generate a lift force to counteract the external force caused by the wind on the respective wing to push the respective wing in a direction opposite the external force and thus to counter roll moments that cause a roll motion of the VTOL aircraft. In some instances, the one or more lift propellers can be activated until the controller 110 determines that the instantaneous roll angle for the VTOL aircraft is less than the roll angle threshold, for example based on feedback provided by the sensors 112 to the controller 110. Alternatively, the one or more lift propellers can be activated for an amount of time specified by the time entry information. In some examples, the controller 110 can communicate with the propeller control system 104 to disable the power being provided to the one or more motors 122 and 124 and thus disable the lift action of one or more selected lift propellers, for example, based on the time entry information. In certain examples, the propellers can be decoupled from the motors for free-spin, thereby disabling their lift force for a selected duration. In other examples, the propeller control system 104 can receive the time entry information, and upon expiration of the time entry information disable the one or more selected lift propellers.

Accordingly, the ATS system 102 can be used to mitigate or suppress a duch-roll motion caused by turbulent conditions during the cruise phase, such as wind gusts. This can be accomplished by activating one or more select lift propellers that are normally stationary (e.g., not active) on a corresponding wing of the VTOL aircraft that the external force is acting upon in response to a turbulent condition. In some instances, during a cruise operation in an absence of a disturbance, “activating” the one or more select lift propellers can mean increasing or decreasing a lift force created by a propeller beyond a steady state to counteract the disturbance. The selected one or more lift propellers are activated to counterbalance the external force and thus remove or mitigate VTOL aircraft instabilities during the cruise phase. Moreover, the ACS system 102 can be implemented in some instances on existing hardware of the VTOL aircraft, such as an existing computer. Without the need for additional hardware, for example, eVTOL manufacturers can keep aircraft weight low thereby allowing for greater flight distances, and mitigating an increase in production costs and complexity as no additional hardware is needed for turbulence suppression according to the examples described herein.

By way of further example, during a normal cruise situation, the one or more lift propellers of the propellers 106 can be stationary. The ATS system 102 can be periodically or continuously configured to compare the instantaneous roll angle of the VTOL aircraft to the roll angle threshold to determine whether the VTOL aircraft is experiencing instability, such as caused by a vertical wind gust. The ATS system 102 can cause one or more selected lift propellers to be activated corresponding to the respective wing that is going through a downward motion. In some examples, the one or more selected lift propellers are one or more outboard propellers on the respective wing. When the respective wing is going through the downward motion, propeller blades of the one or more outboard propellers can be rotated at a speed proportional to the instantaneous roll angle and in some instances for a given amount of time and in accordance with a speed and kinematic profile as specified by the turbulence suppression database 116. The rotation of the propeller blades generates lift to counter the roll moments causing the roll motion on the VTOL aircraft.

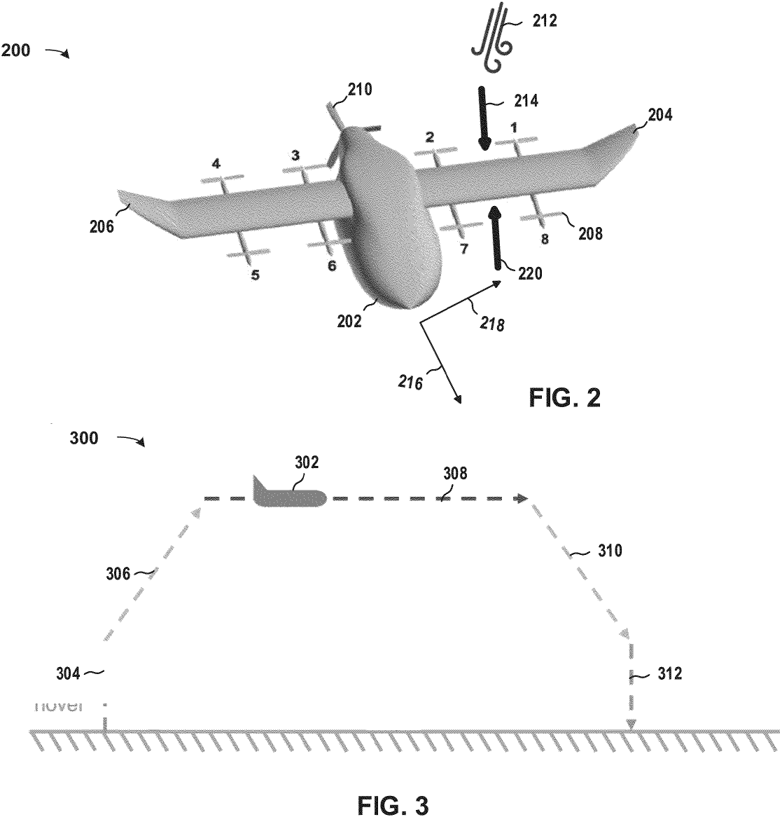

FIG. 2 is an example of a VTOL aircraft 200. The VTOL aircraft 200 can correspond to the VTOL aircraft as described herein with respect to FIG. 1. Thus, reference can be made to the example of FIG. 1 in the example of FIG. 2. In some examples, the VTOL aircraft 200 is an eVTOL aircraft. The VTOL aircraft 200 can include a fuselage 202 and a pair of wings 204 and 206. The VTOL aircraft includes propellers 208, which can be referred to as lift propellers as these propellers function to lift the VTOL aircraft 200.

In the example of FIG. 2, the VTOL aircraft 200 is configured with eight (8) lift propellers 208, respectively labeled by a corresponding number 1-8. The lift propellers 208 identified by numbers 1-4 are located on the trailing edge of a wings 204 and 206, and the lift propellers 208 identified by numbers 5-8 are located on the leading edge of the wings 204 and 206. The lift propellers 208 are placed at a similar span wise location with respect to the leading and trailing edges, as shown in FIG. 2. Each lift propeller of the lift propellers 208 has two (2) blades, as shown in FIG. 2. While the example of FIG. 2 illustrates the lift propellers 208 as having two (2) blades, in other examples the lift propellers 208 can have a greater number of blades. A different number of propellers is also contemplated, as well as a different arrangement thereof.

The VTOL aircraft 200 further includes a propeller 210, which can be referred to as a push propeller as this propeller functions to push the VTOL aircraft 200 through the air. The push propeller 210 is located at a rear of the fuselage 202 of the VTOL aircraft 200. The push propeller 210 includes three (3) blades, but in other examples, can include a different number blades. While the example of FIG. 2 illustrates a single push propeller, in other examples, multiple push propellers can be used on the VTOL aircraft 200. In examples wherein the VTOL aircraft 200 includes two (2) push propellers, the ATS system 102 can control the push propellers to counteract yaw during a Dutch-roll motion of the VTOL aircraft 200.

The VTOL aircraft 200 can include the ATS system 102 as described herein to dampen (e.g., mitigate or suppress) Dutch-roll motion caused by wind, for example, during a cruise phase of the VTOL aircraft 200. Dutch-roll is a coupled motion comprising roll and yaw motions of an aircraft that cause the aircraft to oscillate due to an exchange of energy between these motions. In a coupled phenomenon, such as a Dutch-roll motion, suppression of one of the roll and yaw motions suppresses the Dutch-roll motion. In the examples herein, the roll motion of the aircraft is counteracted to suppress the Dutch-roll motion. However, in other examples, the yaw motion of the aircraft can be counteracted, which suppresses the Dutch-roll motion.

By way of further example, during the cruise phase, wind 212 can create an additional force 214 that can act on the wing 204 of the VTOL aircraft 200, which causes the VTOL aircraft 200 to rotate along a longitudinal axis 216 of the VTOL aircraft 200. During the cruise phase, the lift propellers 208 are stationary, as shown in FIG. 2, and thus not being caused to rotate by the propeller control system 104 unless activated or caused to be activated by the ATS system 102. In certain embodiments, however, the lift propellers 208 may be rotating at steady state, or by action of air streaming past them in a disengaged state from respective motors for driving the lift propellers. The additional force 214 can push the wing 204 in a downward direction with respect to a vertical axis 218 of the VTOL aircraft 200, which causes the VTOL aircraft 200 to roll by a given angle amount with respect to the longitudinal axis 216. The ATS system 102 can determine according to the examples herein that the lift propellers 208 identified by numbers 1 and 8 should be activated corresponding to selected lift propellers 208 to counteract the additional force 214 that is acting on the wing 204 as a result of the wind 212.

The selected lift propellers 1 and 8 are activated to create a lift force 220 in an opposite direction of the external force 212. Because the external force 212 is pushing the right wing in the downward direction, the selected lift propellers 208 once activated create the lift force 220 in an upward direction. The selected lift propellers 1 and 8 can generate the lift force 220 with sufficient energy to counteract the external force 212. The selected lift propellers 208 can generate lift to counter roll moments causing roll motion on the VTOL aircraft 200 by the wind 212. By configuring the VTOL aircraft 200 with the ATS system 102 Dutch-roll oscillations can be actively controlled using existing lift propellers 208. It will also be appreciated that a converse force can be generated, by activating lift propellers 4 and 5 to rotate in the opposite direction and generate a downward moment on the left side, to the same effect. A combination of these rotations of lift propellers 4 and 5, as well as 1 and 8, is also contemplated.

FIG. 3 is an example of a VTOL flight profile 300 for a VTOL aircraft 302. The VTOL aircraft 302 can correspond to the VTOL aircraft 200, as shown in FIG. 2. Thus, reference can be made to the example of FIGS. 1-2 in the example of FIG. 3. The VTOL flight profile 300 can include a takeoff phase 304, a climb phase 306, a cruise phase 308, a descent phase 310, and a landing phase 312. In some examples, the VTOL flight profile 300 can include more or fewer phases but includes the cruise phase 308. The VTOL aircraft 302 can be configured with the ATS system 102 as described herein for dampening (e.g., mitigating or suppressing) disturbances (e.g., wind gusts) that can cause the VTOL aircraft 302 to Dutch-roll oscillate during the cruise phase 308 or even during the other phases. The lift propellers of the VTOL aircraft 302 are activated during one of the phases 304, 306, 310, and 312, and the push propeller of the VTOL aircraft 302 is disabled in phases 304 and 312. During the cruise phase 308 the lift propellers are disabled and the push propeller is activated to provide thrust to move the VTOL aircraft through air until activated or caused to be activated by the ATS system 102 as described herein. Because the VTOL aircraft 302 is configured with the ATS system 102, select lift propellers that had been previously disabled can be enabled to counteract the disturbances acting on the VTOL aircraft 302 during the cruise phase 308.

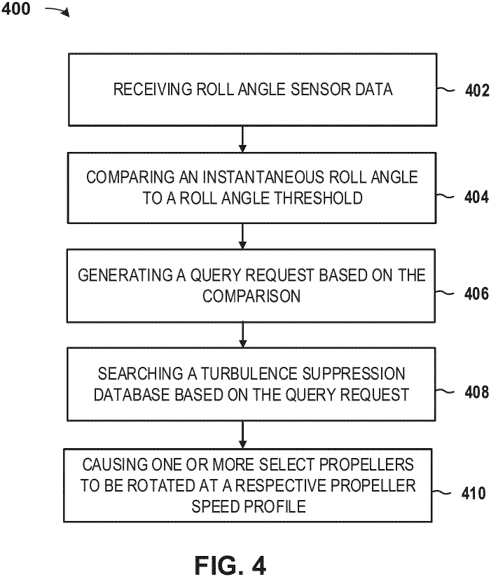

In view of the foregoing structural and functional features described above, an example method will be described with reference to FIG. 4. While, for purposes of simplicity of explanation, the example method of FIG. 4 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods.

FIG. 4 is an example of a method 400 for adjusting flight characteristics of a VTOL aircraft, such as the VTOL aircraft 200, as shown in FIG. 2, or the VTOL aircraft 302, as shown in FIG. 3. The method 400 can be implemented by ATS system 102, as shown in FIG. 1. Thus, reference can be made to the example of FIGS. 1-3 in the example of FIG. 4. The method 400 can begin at 402 by receiving roll angle sensor data, for example, from a roll angle sensor (e.g., the sensor 112, as shown in FIG. 1.). The roll angle sensor data can characterize an instantaneous roll angle of the VTOL aircraft. Roll speed and direction and other roll parameters can be part of this characterization. At 404, comparing the instantaneous roll angle of the VTOL aircraft to a roll angle threshold is performed. At 406, generating a query request (e.g., the query request 114, as shown in FIG. 1) in response to the instantaneous roll angle being equal to or greater than the roll angle threshold is performed. The query request can specify the instantaneous roll angle for the VTOL aircraft. The instantaneous roll angle being equal to or greater than the roll angle threshold can indicate that the VTOL aircraft has deviated or is about to deviate from a current stable aircraft state. The VTOL aircraft can deviate from the current stable aircraft state in response to an external force (e.g., the external force 212, such as caused by a wind gust, as shown in FIG. 2) acting (e.g., pushing) on a respective wing (e.g., the wing 204, as shown in FIG. 1) of the VTOL aircraft in a respective direction that causes the VTOL aircraft to roll by a given angle amount with respect to a longitudinal axis (e.g., the longitudinal axis 216, as shown in FIG. 2). The given angle amount and angle rate of change and direction can correspond to the instantaneous roll angle.

At 408, searching a turbulence suppression database (e.g., the turbulence suppression database 116, as shown in FIG. 1) on the VTOL aircraft for a propeller speed profile for select propellers positioned on the respective wing of the VTOL aircraft is performed. The turbulence suppression database stores turbulence suppression data that has been precomputed using techniques as described herein, for example, before a flight of the VTOL aircraft. At 410, causing the select propellers to rotate at the propeller speed or to otherwise apply the propeller speed profile to generate a lift force that counteracts the external force to push the respective wing in an opposite direction of the external force to counter roll moments that cause a roll motion on the VTOL aircraft is performed.

FIG. 5 is an example of a computing system 500 for generating turbulence suppression data 502. The turbulence suppression data 502 can be stored as part of the turbulence suppression database 116, as shown in FIG. 1. Thus, reference can be made to the example of FIG. 1 in the example of FIG. 5. The turbulence suppression data 502 can specify different propeller speeds and/or speed profiles (including acceleration and deceleration) and in some instances activation times for at least two propellers of a VTOL aircraft, such as the VTOL aircraft 200, as shown in FIG. 2, or the VTOL aircraft 300, as shown in FIG. 3. Thus, reference can be made to the example of FIGS. 1-3 in the example of FIG. 4. In certain embodiments, less than two propellers can be involved in the turbulence suppression procedure. In some examples, the turbulence suppression data 502 corresponds to oscillation suppression data and characterizes revolutions of blades per minute (RPM) of at least two of the propellers of the VTOL aircraft.

The system 500 includes one or more processors 504 and memory 506. The one or more processors 504 could be implemented, for example, as one or more processor cores. By way of example, the memory 506 can be implemented, for example, as a non-transitory computer storage medium, such as volatile memory (e.g., random access memory), non-volatile memory (e.g., a hard disk drive, a solid-state drive, a flash memory, or the like) or a combination thereof. The memory 506 can store machine-readable instructions that can be retrieved and executed by the one or more processors 504 to execute a computational fluid dynamics (CFD) module 508.

Existing control mechanisms that are designed by using aerodynamic data using linear theory, look-up tables, loose coupling, etc., however, do not accurately account for flow complexities of VTOL aircrafts, such as eVTOL aircrafts. In some instances, such low fidelity data (e.g., the aerodynamic data) is modified ad-hoc by using wind tunnel or flight data. The CFD solver module 508 can be programmed to provide the turbulence suppression data 502 (e.g., oscillation suppression data) in a form of RPM of at least two of the propellers to suppress oscillations caused by turbulences. The CFD solver module 508 can be programmed to account for flow complexities associated with VTOL aircrafts (e.g., eVTOL aircrafts) to provide the turbulence suppression data 502, which can be used by the ATS system 102 for mitigating or suppressing oscillations, such as Dutch-roll oscillations.

By way of further example, the CFD solver module 508 can be programmed to simulate fluid flow around the VTOL aircraft using computational fluid dynamic techniques. The CFD solver module 508 can include a 3-D solver that can be programmed to solve time-dependent, Reynolds-averaged, and Navier-Stokes equations using multiple overset structured grids. In some examples, the CFD solver module 508 can be implemented as NASA’s OVERFLOW Overset Grid CFD Flow Solver. The CFD solver module 508 can be programmed to account for flow complexities, such as propeller-wing interactions, flow separations, vortices, etc. Thus, in some examples, the CFD solver module 508 can be programmed based on Unsteady Reynolds-averaged Navier-Stokes (URANS) equations. The CFD solver module 508 can be programmed to model (e.g., within a given degree of accuracy) rigid body movement of propellers of the VTOL aircraft, including blade rotations, along with rolling and yawing motions. Flow can be modeled by the CFD solver module 508 with the URANS equations using an overset grid.

The CFD solver module 508 can include an alternating direction algorithm. In some examples, the alternating direction algorithm is implemented as a Beam-Warming alternate direction implicit algorithm. A diagonal form of the Beam-Warming alternate direction implicit algorithm of a URANS model, which can include the URANS equations, can be used in combination with an eddy turbulent viscosity model by the CFD solver module 508. In some examples, the eddy turbulent viscosity model is a Spalart-Allmaras turbulence model. In further examples, the diagonal-form of the Beam-Warming alternate direction implicit algorithm option of the URANS flow solver OVERFLOW can be used, such as described in Buning, P. G. and Pulliam, T. H., “Near-Body Grid Adaption for Overset Grids,” AIAA 2016, 46th AIAA Fluid Dynamics Conference, 2016, along with the Spalart-Allmaras turbulence model, as described in Spalart, P. R., “Direct Simulation of a Turbulent Boundary Layer,” Journal of Fluid Mechanics, Cambridge University Press, 1988, 187, pp. 61-98, both of which are incorporated herein by reference in entirety.

The CFD solver module 508 can be programmed to model rotating blades of the VTOL aircraft with rigid body motions based on the URANS and the eddy turbulent viscosity models. An overset grid for modeling the rotating blades of the VTOL aircraft can be a given number of grid points, for example, 20 million grid points. For example, the CFD solver module 508 can be programmed to receive input parameter data 510, which can specify the given number of grid points.

The CFD solver module 508 can include a turbulence model 510 and a VTOL aircraft model 512. The VTOL aircraft model 512 can be provided based on the input parameter data 510 and can model the VTOL aircraft, including propellers (e.g., lift and thrust propellers) and blades of the propellers. The turbulence model 512 can be used to simulate turbulence conditions such as wind gusts that cause the VTOL aircraft to experience Dutch-roll oscillations. The CFD solver module 508 can be programmed to control oscillations due to Dutch-roll lateral instability during a cruise phase of a VTOL flight profile for VTOL aircraft model 514 during simulation. For example, the CFD solver module 508 can be programmed to use the following Dutch-roll equation during VTOL aircraft flight simulation to simulate a Dutch-roll oscillation:

$$\ddot{β} + \left(\frac{{N}_{β}}{{I}_{Z}} - {α}_{0} \frac{{L}_{β}}{{I}_{X}}\right) β = 0.0 \qquad \text{(1)}$$

wherein, L and N are rolling and yaw moments of the VTOL aircraft model 512, respectively, I_{X} and I_{Z} are moments of inertia about x and z-axis of the VTOL aircraft model 514 respectively, β is a side slip angle of the VTOL aircraft model 514, α₀ is an angle of attack of the VTOL aircraft model 514, L_{β} and N_{β} are rates of change of roll and yawing moments with respect to the side slip angle β, respectively.

The CFD solver module 508 can be programmed to solve equation (1) for example using numerical time integration during the simulation for computing the turbulence suppression data 502. For example, the CFD solver module 508 can be programmed to compute roll and yaw rates according to the following equations, respectively:

$$\dot{p} = \frac{{L}_{β} β}{{I}_{X}} \qquad \text{(2)}$$

$$\dot{r} = \frac{{N}_{β} β}{{I}_{z}} \qquad \text{(3)}$$

wherein ṗ and ṙ are the roll and yaw rates, respectively.

In some examples, the CFD solver module 508 can be programmed to compute the roll and yaw rates for the VTOL aircraft model 514 by solving equation (1) with numeral time integration according to Guruswamy, G. P., “Dutch-Roll Stability Analysis of an Air Mobility Vehicle Using Navier-Stokes Equations,” AIAA JOURNAL, Vol. 59, No. 10, October 2021 (published online 30 Apr. 2021), which is incorporated herein by reference in its entirety.

By way of further example, the CFD solver module 508 can be programmed to simulate the cruise phase of the VTOL aircraft based on the turbulence and the VTOL aircraft models 512 and 514, respectively. During the simulation, lifting propellers of the VTOL aircraft model 514 can be stationary for a given period of time and the VTOL aircraft model 514 can be programmed to oscillate during the simulation, such as Dutch-roll oscillation according to equation (1). Select lift propellers of the VTOL aircraft model 514 can be activated during the simulation corresponding to a wing that is going through a downward motion (e.g., caused by the turbulence model 512) during a Dutch-roll simulation of the VTOL aircraft model 514. For example, outboard propellers can be selected for active suppression during the simulation.

In some instances, the VTOL aircraft model 514 is representative of the VTOL aircraft 200, as shown in FIG. 1, and the propellers 208 identified with numbers 1 and 8 for the wing 204, and the propellers 208 identified with numbers 4 and 5 are selected for active control simulation. When the wing is undergoing downward motion during the simulation (e.g., based on the turbulence model 512), propeller blades for example for the wings identified with numbers 1, 4, 5, and/or 8 are rotated at a speed proportional to a roll angle for the VTOL aircraft model 514. The propeller blades during the simulation generate additional lift to counter roll moments causing a rolling motion of equation (2). The CFD solver module 508 can be programmed to compute an RPM for each wing of the VTOL aircraft model 514 that includes respective select propellers 1, 4, 5, and 8 for counteracting the oscillation, for example, to provide the turbulence suppression data 502. For example, the RPM for each wing can be computed according to the following equation:

$$Ω = C ϕ \qquad \text{(4)}$$

wherein Ω corresponds to an RPM for a selected propeller, C is an arbitrary constant, and Φ is a roll angle in radians for the VTOL aircraft model 514 during the simulation.

The arbitrary constant in equation (4) can be defined according to the following equation:

$$\text{C} = \frac{L}{d R} \qquad \text{(5)}$$

wherein L is the roll moment of the VTOL aircraft model 514 during the simulation, d is a distance of outboard propellers (e.g., the selected propellers) from a fuselage centerline of a fuselage of the VTOL aircraft model 514, and R is a rate change of thrust from active propellers with respect to RPM.

The coefficient R in equation (5) can vary linearly during the simulation with RPM and can be computed by the CFD solver module 508 as a difference between thrusts generated by the active propellers (e.g., the select 1 and 8 or 4 and 5) from 1,000 RPM to 500 RPM, divided by 500.

In some examples, the input parameter data 510 can specify a rotating speed for blades of the active propellers during the simulation and the CFD solver 508 can use the specified rotating blade speeds to facilitate a change in RPM at every simulation step in some instances to provide the turbulence suppression data 502. The rotating speed blades in some instances can be prescribed as described in Nichols, R. H. and Buning, P. G., “User’s Manual for OVERFLOW 2.3,” April 2020, Langley Research Center, Hampton Virginia, April 2020, which is incorporated herein by reference in its entirety. The CFD solver 508 can be programmed to run in restart mode after each simulation step. The RPM can be computed by the CFD solver 508 using the roll moment L (e.g., from equation (5)) at each simulation step, and can be inputted to a subsequent simulation step, through an interface. The interface may correspond to the interface as described in “Dynamic Aeroelasticity of Wings with Tip Propeller by Using Navier-Stokes Equations,” Guruswamy, G. P., AIAA Journal, Vol. 57, Issue 8, August 2019. DOl: 10.2514/1.J058610, which is incorporated herein by reference in its entirety.

In further examples, the input parameter data 510 can specify properties for the VTOL aircraft model 514 that can be used during the simulation. The input parameter data 510 can specify a span for wings of the VTOL aircraft model 514 (e.g., a wing span of 30 feet), a dynamic pressure (e.g., a dynamic pressure of 120.0 lb/sqft), an inertia moment about the x-axis of the VTOL aircraft model 514 (e.g., Iₓ of 8,000 lb-ft-sec²), an inertia moment about the y-axis (e.g., e.g., I_{Z} of 100,000 lb-ft-sec²), an altitude (e.g., an altitude of 3,000 feet) of the VTOL aircraft model 514, and a cruise Mach number of the VTOL aircraft model 514 (e.g. a cruise Mach number of 0.2). One or more push propellers of the VTOL aircraft model 512 can be programmed to rotate at about 2,800 revolutions per minute during the simulation and the lifting propellers are not allowed to rotate for a given amount of time during the cruise phase simulation of the VTOL aircraft model 514.

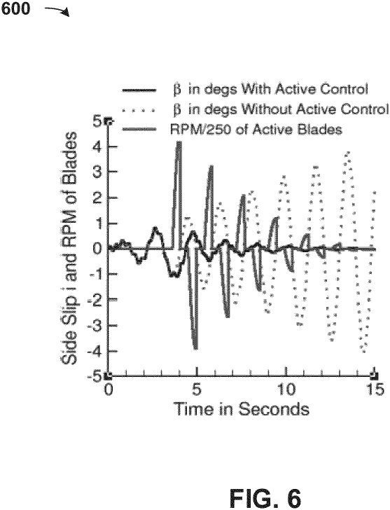

The CFD solver module 508 can be programmed to implement a one-degree step initial input to roll and yaw angles (e.g., to simulate a sudden gust) to provide a neutral Dutch-roll oscillation. Computations with 90% of I_{X} show diverging motion as seen in FIG. 6. FIG. 6 is an example of a diagram 600 illustrating a side slip angle for the VTOL aircraft model 514. As shown in FIG. 6, the outboard propellers are activated three (3) seconds after the start of the Dutch-roll oscillation during the simulation. FIG. 6 shows a stabilizing response of side slip angle in time. Activation of select lift propellers of the VTOL aircraft model 514 during simulation suppress Dutch-roll oscillation.

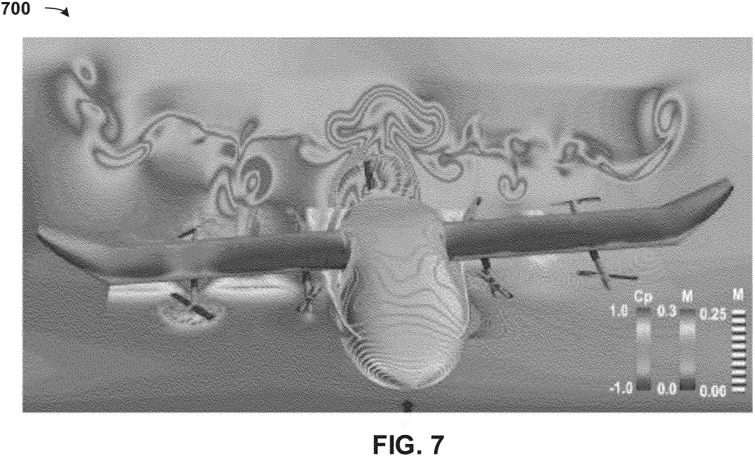

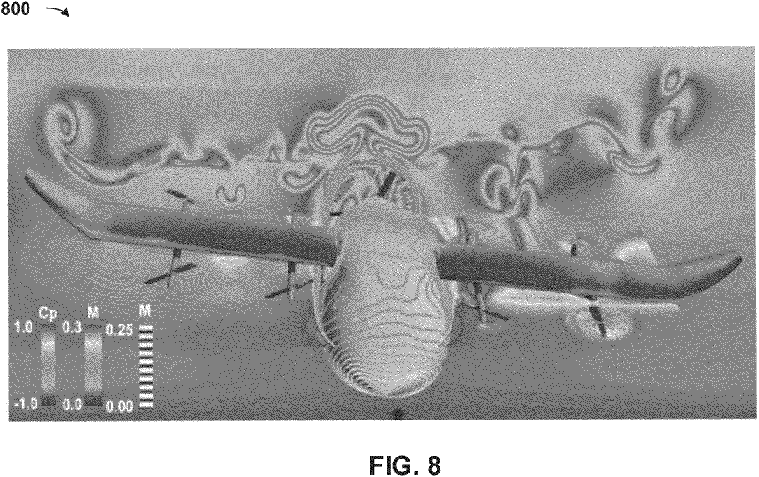

FIGS. 7-8 are example of plots 700 and 800 of surface pressures and Mach contours when respective left and right wing outboard propellers are activated of the VTOL aircraft model 514. In the example of FIGS. 7-8, pressures on a surface are shown as a carpet map on the left and right wings, respectively, and line contours on a body. Mach number contours are shown as contour lines in a plane of the wings and using black & white zebra scaling on a plane behind the pushing propellers.

What have been described above are examples. It is, of course, not possible to describe every conceivable combination of components or methods, but one of ordinary skill in the art will recognize that many further combinations and permutations are possible. Accordingly, the invention is intended to embrace all such alterations, modifications, and variations that fall within the scope of this application, including the appended claims. Where the disclosure or claims recite “a,” “an,” “a first,” or “another” element, or the equivalent thereof, it should be interpreted to include one or more than one such element, neither requiring nor excluding two or more such elements. As used herein, the term “includes” means includes but not limited to, the term “including” means including but not limited to. The term “based on″ means based at least in part on.”

What is claimed is:

1. A system comprising:
a controller configured to:
receive input that a vertical take-off and landing (VTOL) aircraft is oscillating off-nominally;
receive sensor data characterizing at least an instantaneous roll angle of the VTOL aircraft; and
generate a query request in response to the instantaneous roll angle being equal to or greater than a roll angle threshold, wherein the instantaneous roll angle being equal to or greater than the roll angle threshold indicates that the VTOL aircraft has deviated or is about to deviate from a stable aircraft state; and
a database configured to provide propeller control data identifying a respective propeller speed profile for one or more propellers of the VTOL aircraft in response to the query request, wherein the database stores different propeller speed profiles for the one or more propellers of the VTOL aircraft for respective roll angles, and
wherein the controller is further configured to cause the one or more propellers of the VTOL aircraft to rotate at the identified respective propeller speed profile, and to return the VTOL aircraft to the stable aircraft state.

2. The system of claim 1, wherein the different propeller speed profiles for the one or more propellers of the VTOL aircraft for the respective roll angles correspond to pre-computed data that has been determined using a flight model prior to a flight of the VTOL aircraft.

3. The system of claim 2, wherein the flight model includes a computational dynamics fluid (CFD) programmed to simulate effects of a disturbance on the VTOL aircraft to determine the different propeller speed profiles for one or more propellers of the VTOL aircraft.

4. The system of claim 3, wherein the VTOL aircraft deviates from the stable aircraft state in response to an external force caused by the disturbance acting on a respective wing of the VTOL aircraft in a respective direction, the external force causing the VTOL aircraft to roll by a given angle amount with respect to a longitudinal axis of the VTOL aircraft, wherein the given angle amount corresponds to the instantaneous roll angle.

5. The system of claim 4, wherein the query request identifies the instantaneous roll angle, and the database is configured to identify the respective propeller speed for the at least two propellers based on the instantaneous roll angle.

6. The system of claim 5, wherein each propeller speed profile in the database is associated with a time entry specifying an amount of time that the at least two propellers are activated at the respective propeller speed, and the propeller control data further includes the time entry associated with the respective propeller speed for the at least two propellers of the VTOL aircraft.

7. The system of claim 6, wherein the controller and the database form an active turbulence suppression (ATS) system, and the aircraft vehicle system further comprises a propeller control system for controlling the at least two propellers, the controller being configured to generate propeller activation data specifying the respective propeller speed, and the propeller control system being configured to rotate the at least two propellers of the VTOL aircraft at the respective propeller speed in response to receiving the propeller activation data.

8. The system of claim 7, wherein the VTOL aircraft comprises a plurality of lift propellers and a push propeller, the at least two propellers of the VTOL aircraft correspond to a subset of propellers of the plurality of lift propellers and are positioned on the respective wing of the VTOL aircraft.

9. The system of claim 8, wherein the propeller activation data further identifies the subset of propellers and the propeller control system is configured to identify the subset of propellers for activation at the respective speed based on the propeller activation data, further comprising a power system, and the propeller control system is configured to communicate with the power system to receive power for powering respective motors associated with the subset of propellers.

10. The system of claim 1, wherein the power system is a battery power system and comprises one or more batteries for providing power to the respective motors, the respective motors are electrical motors, and the VTOL aircraft is an eVTOL aircraft.

11. A method comprising:
receiving input at a controller that a vertical take-off and landing aircraft is oscillating off-nominally;
receiving roll angle sensor data characterizing an instantaneous roll angle of the VTOL aircraft;
generating a query request in response to the instantaneous roll angle being equal to or greater than the roll angle threshold, wherein the instantaneous roll angle being equal to or greater than the roll angle threshold indicates that the VTOL aircraft has deviated or is about to deviate from a stable aircraft state in response to an external force acting on a respective wing of a set of wings of the VTOL aircraft;
identifying at least one propeller of a plurality propellers of the VTOL aircraft positioned on the respective wing of the VTOL aircraft for counteracting the external force acting on the respective wing to return the VTOL aircraft to the stable aircraft state;
searching a turbulence suppression database for a propeller speed profile for the at least one propeller based on the query request, wherein the turbulence suppression database stores different propeller speed profiles for propellers for respective roll angles;
generating propeller activation data that includes the propeller speed profile; and
causing the proper subset of propellers to rotate at a propeller speed specified in the propeller speed profile to generate a force to counteract the external force to push the respective wing in an opposite direction of the external force, and to return the VTOL aircraft to the stable aircraft state based on the propeller activation data.

12. The method of claim 11, wherein searching the turbulence suppression database comprises identifying a time entry specifying an amount of time that the at least one propeller is activated at the propeller speed specified in the propeller speed profile, wherein time entry is associated with the propeller speed profile and stored in the turbulence suppression database.

13. The method of claim 12, wherein the propeller activation data further includes the time entry associated with the propeller speed profile for the at least one propeller.

14. A vertical take off and landing (VTOL) aircraft comprising:
a fuselage;
at least two wings extending from the fuselage;
a push propeller positioned at a rear of the fuselage;
a plurality of lift propellers equally distributed on the at least two wings; and
an active turbulence suppression (ATS) system, the ATS system being configured to:
generate propeller control data identifying a respective propeller speed profile for at least one lift propeller of the plurality of lift propellers located on a respective wing of the at least two wings in response to querying a turbulence suppression database, wherein the turbulence suppression database stores different propeller speed profiles for propellers of the VTOL aircraft for respective roll angles, and the turbulence suppression database is queried in response to the ATS system determining that an instantaneous roll angle of the VTOL aircraft is equal to or greater than a roll angle threshold, wherein the instantaneous roll angle being equal to or greater than the roll angle threshold indicates that the VTOL aircraft has deviated or is about to deviate from a stable aircraft state in response to turbulence; and
cause the at least one lift propeller of the VTOL aircraft to rotate at the respective propeller speed for the at least one lift propeller based on the propeller speed profiles to return the VTOL aircraft to the stable aircraft state.

15. The VTOL aircraft of claim 14, further comprising at least one sensor configured to provide the instantaneous roll angle of the VTOL aircraft, and the ATS system comprising a controller configured to query the turbulence suppression database using the instantaneous roll angle to identify the respective propeller speed profile for the at least one lift propeller of the VTOL aircraft.

16. The VTOL aircraft of claim 15, wherein the controller is configured to cause the at least one lift propeller of the VTOL aircraft to rotate at the respective propeller speed as specified in the propeller speed profile for a given amount of time to return the VTOL aircraft to the stable aircraft state, wherein the given amount of time is specified by the turbulence suppression database.

17. The VTOL aircraft of claim 16, wherein the ATS system includes the turbulence suppression database.

18. The VTOL aircraft of claim 17, further comprising a propeller control system that is configured to rotate the at least one lift propeller of the VTOL aircraft at the respective propeller speed as specified in the propeller speed profile in response to receiving the propeller activation data for the given amount of time.

19. The VTOL aircraft of claim 18, wherein the ATS system is activated for controlling the at least one lift propeller during a cruise phase of a VTOL flight profile for the VTOL aircraft.

20. The VTOL aircraft of claim 19, wherein the plurality of lift propellers are activated during a non-cruise phase of the VTOL flight profile for the VTOL aircraft and deactivated in response to the VTOL aircraft entering or transitioning into the cruise phase, and the at least one lift propeller is deactivated for a portion of time during the cruise phase of the VTOL flight profile and activated for another portion of time during the cruise phase of the VTOL flight profile to rotate the at least one lift propeller at the respective propeller speed as specified in the propeller speed profile to return the VTOL aircraft to the stable aircraft state.
